(19) United States
(12) Patent Application Publication
(10) Pub. No.: US 2013/0321743 A1
(43) Pub. Date: Dec. 5, 2013

(54) BACKLIGHT MODULE AND LIQUID CRYSTAL DISPLAY

(71) Applicant: Synergy Optoelectronics (Shenzhen) Co., Ltd., Shenzhen (CN)

(72) Inventors: BING XU, Shenzhen (CN); SUI-MANG SONG, Shenzhen (CN); CHIEN-CHUNG FANG, Hsinchu (TW)

(73) Assignee: SYNERGY OPTOELECTRONICS (SHENZHEN) CO., LTD., Shenzhen (CN)

(21) Appl. No.: 13/904,166

(22) Filed: May 29, 2013

(30) Foreign Application Priority Data
May 31, 2012 (CN) 2012101762145

(51) Int. Cl. G02F 1/1335; F21V 8/00

(52) U.S. Cl. CPC G02F 1/133615; G02B 6/0031
USPC 349/65; 362/609

(57) ABSTRACT

A backlight module includes a light guide plate and a light source. The light guide plate includes a light incident surface, a bottom surface adjacent to the light incident surface, and a light emitting surface opposite to the bottom surface. The light source is positioned adjacent to the light incident surface, and includes a reflective block and a first point light source. The reflective block includes a first reflective surface facing the light incident surface. An air gap is defined between the first reflective surface and the light incident surface. The first reflective surface includes a first end and a second end. A distance between the first reflective surface and the light incident surface increases gradually along a direction from the first end to the second end.

### BACKGROUND

1. Technical Field

The present disclosure relates to a backlight module and a liquid crystal display using the same.

2. Description of Related Art

A typical liquid crystal display (LCD) device includes an LCD panel, and a backlight module mounted behind the LCD panel for supplying light beams to the LCD panel. The backlight module may include a light guide plate and a plurality of light emitting diodes (LEDs) arranged at a side surface of the light guide plate. However, a gap is usually defined between two adjacent LEDs, such that a region of the light guide plate facing the gap may have a brightness that is lower than other surrounding regions. Accordingly, light emitted by the backlight module may be not uniform, and image quality of the LCD panel is also limited.

What is needed is to provide a backlight module and an LCD that can overcome the above-described limitations.

### BRIEF DESCRIPTION OF THE DRAWINGS

The components in the drawings are not necessarily drawn to scale, the emphasis instead placed upon clearly illustrating the principles of at least one embodiment. In the drawings, like reference numerals designate corresponding parts throughout the various views, and all the views are schematic.

FIG. 1 is an exploded, isometric view of an LCD according to a first embodiment of the present disclosure.

FIG. 2 is an assembled view of the LCD of FIG. 1.

FIG. 3 is a cross-sectional view of the LCD of FIG. 2 taken along line III-III.

FIG. 4 is an exploded, isometric view of an LCD according to a second embodiment of the present disclosure.

FIG. 5 is a cross-sectional view of the LCD of FIG. 4.

### DETAILED DESCRIPTION

Reference will be made to the drawings to describe certain exemplary embodiments of the present disclosure.

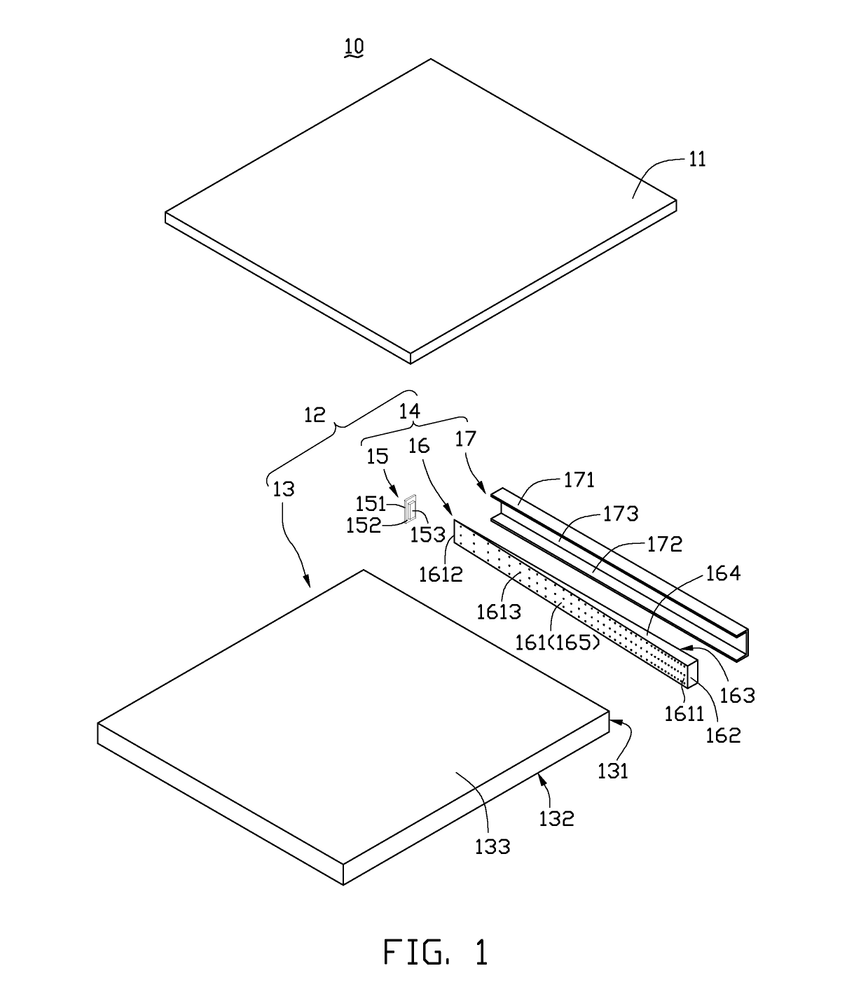

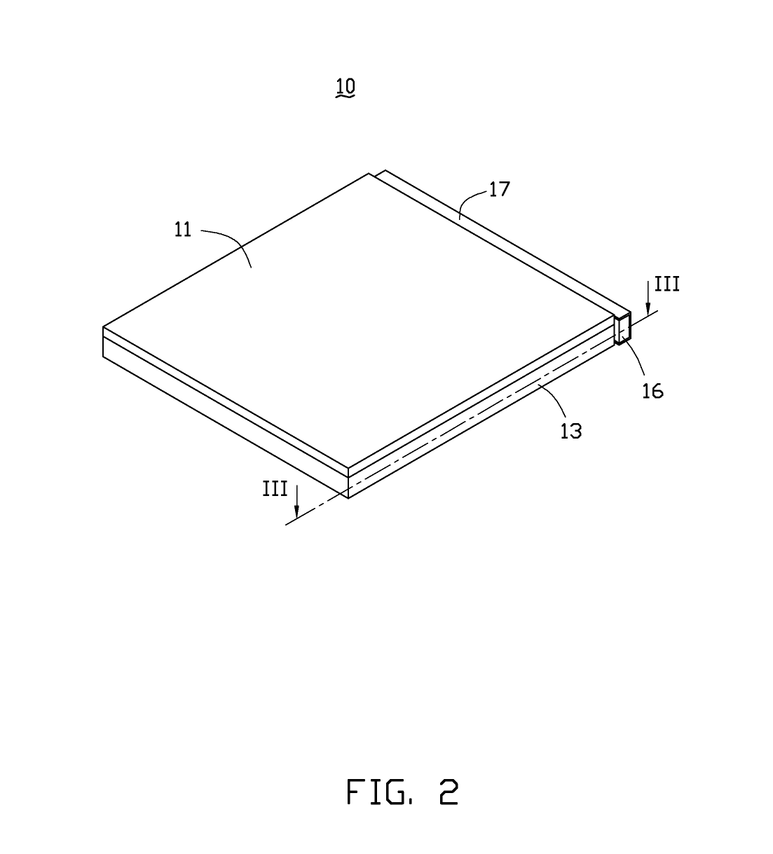

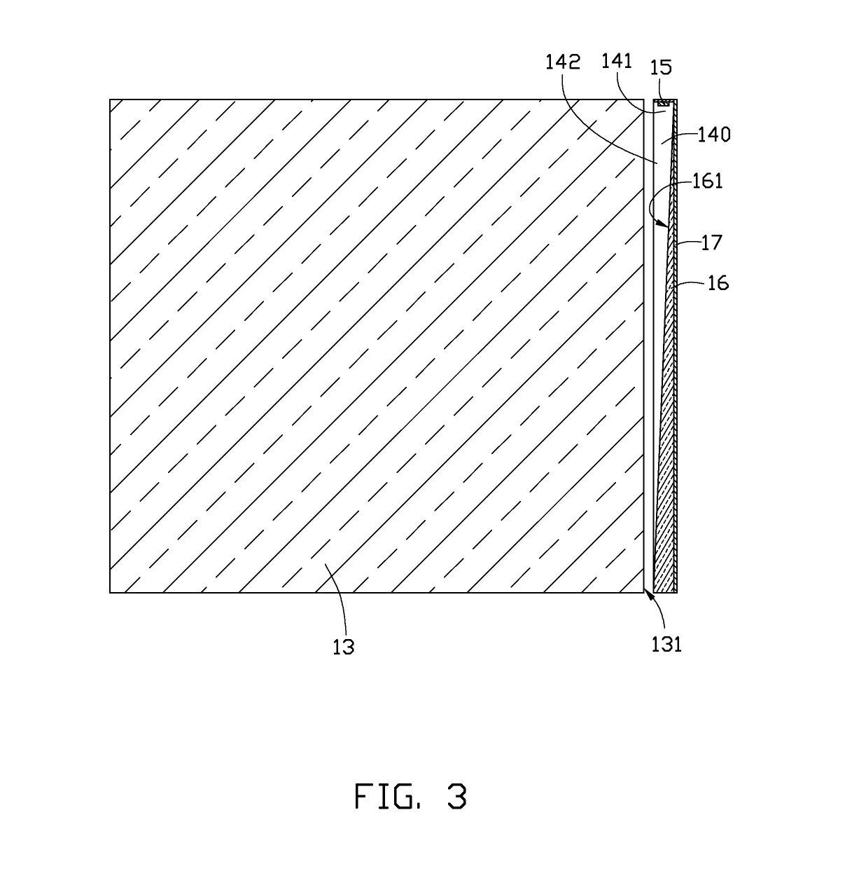

Referring to FIGS. 1-3, an LCD 10 according to a first embodiment of the present disclosure is shown. The LCD 10 includes an LCD panel 11 and a backlight module 12 mounted behind the LCD panel 11 for supplying light beams to the LCD panel 11. The backlight module 12 includes a light guide plate 13 and a light source 14. The light guide plate 13 includes a light incident surface 131, a bottom surface 132 adjacent to the light incident surface 131, and a light emitting surface 133 opposite to the bottom surface 132. The light source 14 is positioned adjacent to the light incident surface 131, and includes a point light source 15, a reflective block 16, and a reflective housing 17.

The reflective block 16 is positioned adjacent to the light incident surface 131, and includes a reflective surface 161. The reflective surface 161 and the light incident surface 131 define an air gap between the reflective surface 161 and the light incident surface 131. The reflective surface 161 includes a first end 1611 and a second end 1612 opposite to the first end 1611. The two ends 1611 and 1622 face two ends of the light incident surface 131 respectively. A distance between the reflective surface 161 and the light incident surface 131 increases gradually along a direction from the first end 1611 to the second end 1612.

In one embodiment, the reflective surface 161 is perpendicular to the light emitting surface 131. The reflective surface 161 may include a plurality of reflective particles 1613, and a density of the reflective particles 1613 decreases gradually along the direction from the first end 1611 to the second end 1612. In one embodiment, the reflective block 16 is a triangular prism, and includes two bottom surfaces 164, a first side surface 165, a second side surface 162, and a third side surface 163. The two bottom surfaces 164 are parallel to the light emitting surface 133. The first side surface 165 is served as the reflective surface 161. The third side surface 163 is parallel to the light incident surface 131. The second side surface 162 is perpendicular to the third side surface 163.

The reflective housing 17 includes a first extending plate 171, a second extending plate 172, and a connection plate 173. The first extending plate 171 and the second extending plate 172 are parallel to the light emitting surface 133. The connection plate 173 is perpendicularly connected between the first extending plate 171 and the second extending plate 172. In the embodiment, the reflective block 16 is received in a receiving space defined by the first extending plate 171, the second extending plate 172, and the connection plate 173. The third side surface 163 is adjacent to an internal surface of the connection plate 173. The reflective surface 161, an internal surface of the first extending plate 171, and an internal surface of the second extending plate 172 define a light transmission space 140 having a first opening 141 facing the point light source 15 and a second opening 142 facing the light incident surface 131. The internal surfaces of the first extending plate 171 and the second extending plate 172 may use reflective material. In alternative embodiment, the reflective block 16 and the reflective housing 17 can be integrated into one piece.

The point light source 15 is positioned adjacent to the second end 1612, and includes a base plate 151 and a light emitting element 153. The base plate 151 includes a supporting surface 152 perpendicular to the light incident surface 131 and the light emitting surface 133. The light emitting element 153 is fixed on the supporting surface 152. In one embodiment, the light emitting element 153 can be a white light emitting diode (LED). The light emitting element 153 has a top surface for emitting light away from the supporting surface 152. The base plate 151 is clamped by the first extending plate 171 and the second extending plate 172, such that the base plate 151 is fixed between the first extending plate 171 and the second extending plate 172.

When the backlight 12 is in operation, light emitted by the light emitting element 153 enters into the light transmission space 140 via the first opening 141 and then reflects by the reflective surface 161, the reflected light enters into the light incident surface 131 via the second opening 142, and accordingly, the light guiding plate 13 provides flat light to the liquid crystal panel 11 via light emitting surface 133.

In summary, because the reflective surface 161 can provide uniform light to the light guiding plate 13, such that light emitted by the backlight module 11 is also uniform, and image quality of the LCD panel 12 is also improved.

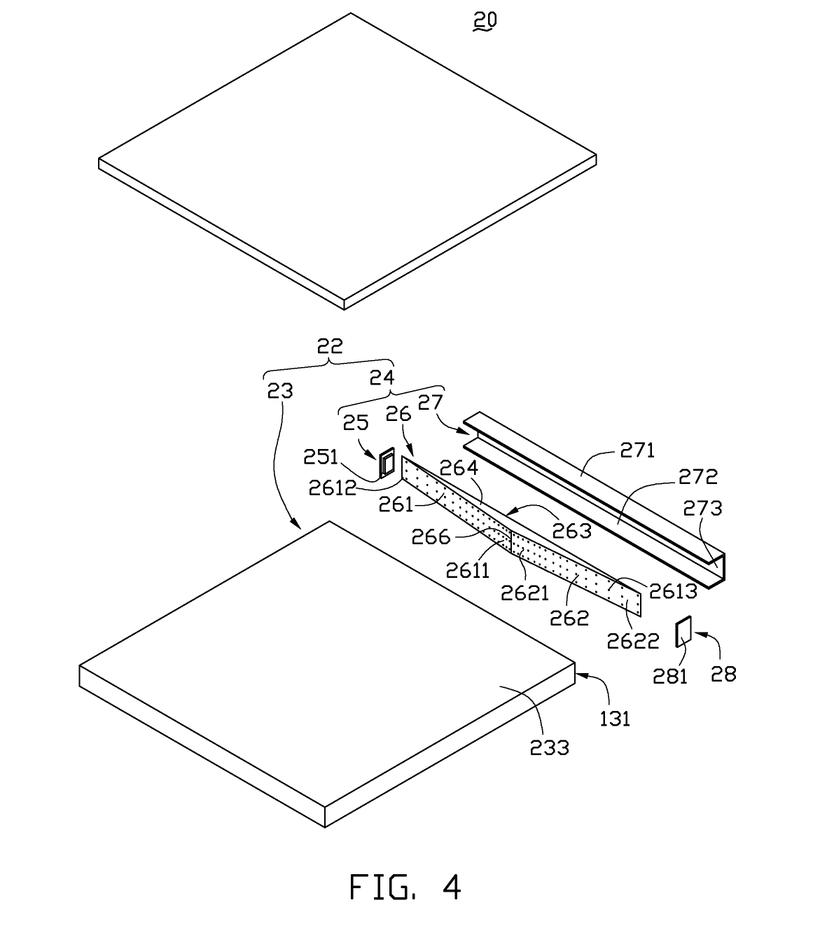

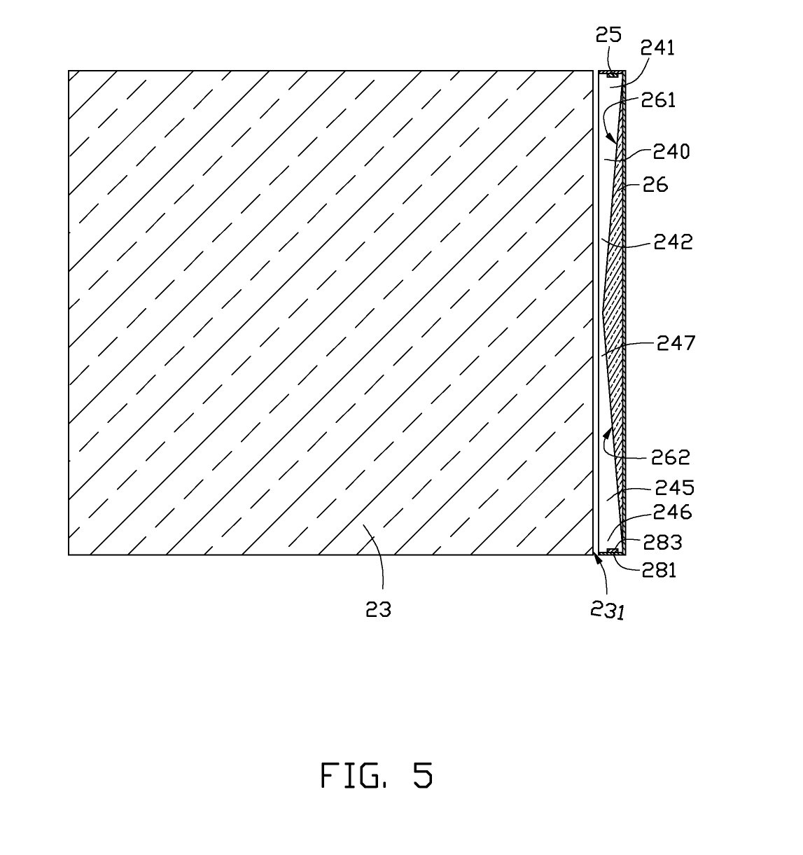

Referring to FIG. 4 and FIG. 5, an LCD 20 according to a second embodiment of the present disclosure is shown. The LCD 20 differs from the LCD 10 in that light source 24 includes a first point light source 25 and a second point light source 28, and the reflective block 26 includes two bottom surfaces 264, a first reflective surface 261, a second reflective surface 262, and a side surface 263. The two bottom surfaces 264 are parallel to light emitting surface 233. The first reflective surface 261, the second reflective surface 262, and the side surface 263 are served as three side surfaces of the triangular prism of the reflective block 26. The side surface 263 and each of the first reflective surface 261 and the second reflective surface 262 form an acute angle. Both of the first reflective surface 261 and the second reflective surface 262 face the light incident surface 231, and are inclined to the light incident surface 231.

The two reflective surfaces 261 and 262 intersect with each other and define an intersect line 266 located between the two reflective surfaces 261 and 262. In one embodiment, the intersect line 266 is perpendicular to the light emitting surface 233 and face a center of the light incident surface 231, and the bottom surface 264 is an isosceles triangle. The first reflective surface 261 includes a first end 2611 adjacent to the intersect line 266 and an opposite second end 2612. The first point light source 25 is positioned adjacent to the second end 2612. A first air gap is defined between the first reflective surface 261 and the light incident surface 231. A distance between the first reflective surface 261 and the light incident surface 231 increases gradually along a direction from the first end 2611 to the second end 2612. The second reflective surface 262 includes a first end 2621 adjacent to the intersect line 266 and an opposite second end 2622. The first ends 2611 and 2621 are located two sides of the intersect line 266. The second point light source 25 is positioned adjacent to the second end 2622. A second air gap is defined between the second reflective surface 262 and the light incident surface 231. A distance between the second reflective surface 262 and the light incident surface 231 increases gradually along a direction from the first end 2621 to the second end 2622.

The first reflective surface 261 includes a plurality of reflective particles 2613, and a density of the reflective particles 2613 decreases gradually along the direction from the first end 2611 to the second end 2612. The second reflective surface 262 also includes a plurality of reflective particles 2613, and a density of the reflective particles 2613 decreases gradually along the direction from the first end 2621 to the second end 2622.

In the second embodiment, the reflective block 26 is also received in a receiving space of a reflective housing 27. The first reflective surface 261, an internal surface of a first extending plate 271, and an internal surface of a second extending plate 272 define a first light transmission space 240 having a first opening 241 facing the point light source 25 and a second opening 242 facing the light incident surface 231. The second reflective surface 262, an internal surface of the first extending plate 271, and an internal surface of the second extending plate 272 define a second light transmission space 245 having a first opening 246 facing the second point light source 28 and a second opening 247 facing the light incident surface 231.

The first point light source 25 and the second point light source 28 have the same structure with the point light source 15. The first extending plate 271 and the second extending plate 272 clamp base plates 251 and 281 of the first point light source 25 and the second point light source 28 to fix the first point light source 25 and the second point light source 28.

When the backlight 22 is in operation, light emitted by a first point light source 25 enters into the first light transmission space 240 via the first opening 241 and then reflects by the first reflective surface 261, the reflected light from the first reflective surface 261 enters into the light incident surface 231 via the second opening 242. Simultaneously, light emitted by a second point light source 25 enters into the second light transmission space 245 via the first opening 246 and then reflects by the second reflective surface 262, the reflected light from the second reflective surface 262 enters into the light incident surface 231 via the second opening 247. Accordingly, the light guiding plate 13 receives the reflective light from the first and the second reflective surfaces 261 and 262 and provides flat light to the liquid crystal panel 11 via light emitting surface 233.

It is to be further understood that even though numerous characteristics and advantages of preferred and exemplary embodiments have been set out in the foregoing description, together with details of the structures and functions of the embodiments, the disclosure is illustrative only; and that changes may be made in detail, especially in the matters of shape, size and arrangement of parts within the principles of the present disclosure to the full extent indicated by the broad general meaning of the terms in which the appended claims are expressed.

What is claimed is:

1. A backlight module, comprising:
a light guide plate comprising a light incident surface, a bottom surface adjacent to the light incident surface, and a light emitting surface opposite to the bottom surface; and
a light source positioned adjacent to the light incident surface, the light source comprising:
a reflective block comprising a first reflective surface facing the light incident surface, an air gap defined between the first reflective surface and the light incident surface; the first reflective surface comprising a first end and a second end, a distance between the first reflective surface and the light incident surface increasing gradually along a direction from the first end to the second end, and
a first point light source positioned adjacent to the second end,
wherein light emitted by the first point light source is reflected by the first reflective surface and then is provided to the light incident surface.

2. The backlight module of claim 1, wherein the first point light source comprises a base plate and a light emitting element; the base plate comprising a supporting surface perpendicular to the light incident surface, and the light emitting element positioned on the supporting surface.

3. The backlight module of claim 1, wherein the first reflective surface is perpendicular to the light emitting surface.

4. The backlight module of claim 3, wherein the reflective block is a triangular prism and comprises two bottom surfaces, a first side surface, a second side surface, and a third side surface; the two bottom surfaces are parallel to the light emitting surface, and the first side surface serves as the reflective surface.

5. The backlight module of claim 1, wherein the first reflective surface comprises a plurality of reflective particles, and a density of the reflective particles decreases gradually along the direction from the first end to the second end.

6. The backlight module of claim 1, further comprising a reflective housing comprising a first extending plate and a second extending plate parallel to the first extending plate, wherein the reflective block is positioned between the first extending plate and the second extending plate, and the first reflective surface, an internal surface of the first extending plate, and an internal surface of the second extending plate define a light transmission space having a first opening facing the first point light source and a second opening facing the light incident surface.

7. The backlight module of claim 6, wherein the reflective housing further comprises a connection plate connected between the first extending plate and the second extending plate, and the reflective block is received in a receiving space defined by the first extending plate, the second extending plate, and the connection plate.

8. The backlight module of claim 1, wherein the light source further comprises a second point light source, the reflective block further comprises a second reflective surface facing with the light incident surface; an air gap is also defined between the second reflective surface and the light incident surface, the second reflective surface comprises third end and a fourth end, the second point light source is positioned adjacent to the fourth end, a distance between the second reflective surface and the light incident surface increasing gradually along a direction from the third end to the fourth end.

9. The backlight module of claim 8, wherein the first and the second reflective surfaces intersect with each other and define an intersect line located between the first and the second reflective surfaces, and the first end and the third end are located two sides of the intersect line.

10. The backlight module of claim 9, wherein the intersect line is perpendicular to the light emitting surface and faces a center of the light incident surface.

11. A liquid crystal display, comprising:
a liquid crystal panel; and
a backlight module configured to provide light to the liquid crystal panel, the backlight module comprising:
a light guide plate comprising a light incident surface, a bottom surface adjacent to the light incident surface, and a light emitting surface opposite to the bottom surface; and
a light source positioned adjacent to the light incident surface, the light source comprising:
a reflective block comprising a first reflective surface facing the light incident surface, an air gap defined between the first reflective surface and the light incident surface, the first reflective surface comprising a first end and a second end, a distance between the first reflective surface and the light incident surface increasing gradually along a direction from the first end to the second end, and
a first point light source positioned adjacent to the second end,
wherein light emitted by the first point light source is reflected by the first reflective surface and then is provided to the light incident surface.

12. The liquid crystal display of claim 11, wherein the first point light source comprises a base plate and a light emitting element, the base plate comprising a supporting surface perpendicular to the light incident surface, and the light emitting element positioned on the supporting surface.

13. The liquid crystal display of claim 11, wherein the first reflective surface is perpendicular to the light emitting surface.

14. The liquid crystal display of claim 13, wherein the reflective block is a triangular prism and comprises two bottom surfaces, a first side surface, a second side surface, and a third side surface; the two bottom surfaces is parallel to the light emitting surface, and the first side surface serves as the reflective surface.

15. The liquid crystal display of claim 11, wherein the first reflective surface comprises a plurality of reflective particles, and a density of the reflective particles decreases gradually along the direction from the first end to the second end.

16. The liquid crystal display of claim 11, wherein the backlight module further comprises a reflective housing comprising a first extending plate and a second extending plate parallel to the first extending plate; the reflective block is positioned between the first extending plate and the second extending plate, and the first reflective surface; an internal surface of the first extending plate and an internal surface of the second extending plate define a light transmission space having a first opening facing the first point light source and a second opening facing the light incident surface.

17. The liquid crystal display of claim 16, wherein the reflective housing further comprises a connection plate connected between the first extending plate and the second extending plate, and the reflective block is received in a receiving space defined by the first extending plate, the second extending plate, and the connection plate.

18. The liquid crystal display of claim 11, wherein the light source further comprises a second point light source, the reflective block further comprises a second reflective surface facing with the light incident surface; an air gap is also defined between the second reflective surface and the light incident surface, the second reflective surface comprises third end and a fourth end, the second point light source is positioned adjacent to the fourth end, a distance between the second reflective surface and the light incident surface increasing gradually along a direction from the third end to the fourth end.

19. The liquid crystal display of claim 18, wherein the first and the second reflective surfaces intersect with each other and define an intersect line located between the first and the second reflective surfaces, and the first end and the third end are located two sides of the intersect line.

20. The liquid crystal display of claim 19, wherein the intersect line is perpendicular to the light emitting surface and faces a center of the light incident surface.
